(19) United States
(12) Patent Application Publication
(10) Pub. No.: US 2013/0191093 A1
(43) Pub. Date: Jul. 25, 2013

(54) SYSTEMS FOR ESTIMATING NEW INDUSTRIAL PLANT OPERATIONAL READINESS COSTS

(71) Applicants: James S. Leitch, Anderson, SC (US); James B. Humphries, Greenville, SC (US)

(72) Inventors: James S. Leitch, Anderson, SC (US); James B. Humphries, Greenville, SC (US)

(21) Appl. No.: 13/520,981

(22) PCT Filed: Jan. 7, 2011
(86) PCT No.: PCT/US11/20523

§ 371 Date: Apr. 3, 2013

Related U.S. Application Data
(60) Provisional application No. 61/293,260, filed on Jan. 8, 2010.

(51) Int. Cl. G06F 17/50

(52) U.S. Cl. CPC G06F 17/5009
USPC 703/6

(57) ABSTRACT

Systems and methods of estimating a plant owner readiness are presented. When a plant owner is preparing for a phase deliverable of a plant construction project (e.g., ownership or operating of the plant), the readiness of the owner can be determined. Furthermore, the cost of achieving readiness can be estimated based on attributes of the plant under construction and based previous plant construction project checklists or readiness models. Contemplated systems can also recommend a readiness plan along with a likelihood of plan success.

This application claims the benefit of priority to U.S. provisional application having Ser. No. 61/293260 filed on Jan. 8, 2010. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is production facility planning technologies.

### BACKGROUND

Building a production facility, generically referred to as a “plant”, takes a great deal of planning. Engineering, Procurement Construction, Maintenance (EPCM) companies are well versed in project planning techniques that can be brought to bear to construct a plant. However, physically designing and building a plant represents only one portion of activities necessary in delivering a new production plant to an owner. Another less appreciated but increasingly important aspect of delivering a plant to the owner includes “readying” the owner to complete additional activities so that the owner is capable of taking possession, commissioning, starting up, controlling, managing, or operating the plant.

In a worst case scenario, new plant owners are required to navigate through a myriad of readiness requirements on their own, independent of an EPCM company's effort to build the plant. Unfortunately, many new plant owners find themselves in unfamiliar territory and are ill equipped to determine even the basic readiness requirements. For example, new owners might lack an understanding that readiness requirements can include determining the number of personnel needed, required training, hiring requirements, spare parts and logistics, supply chain management, equipment lists, IT systems, knowledge transfers, safety compliances, maintenance requirements, or other less well known requirements that could severely affect the operational efficiency of the plant if not properly taken into consideration. New owners require better insight into the readiness requirements and estimated costs (e.g., money, time, labor, equipment, etc.) to ready the plant. The estimated costs aid the owner to make better decisions on how to budget and proceed with design, development, or construction of the plant.

In some scenarios, construction companies can aid a new owner in navigating the rough waters of readiness requirements. Unfortunately, readiness requirements for a new plant are custom compiled manually on a project-by-project basis, which result in widely varying and in inaccurate readiness cost estimates. Such an approach is inefficient and time consuming. Some previous effort has been directed toward building computer-based models of facilities.

Interestingly, most previous efforts focus only estimating costs for completion of a construction project. For example, U.S. Pat. No. 5,189,606 to Burns et al. titled “Totally Integrated Construction Cost Estimating, Analysis, and Reporting System”, filed May 14, 1991, describes a construction cost generator that leverages information associated with over 900 types of Air Force facilities. Still, Burns fails to take into account estimating a readiness cost for readying an owner of a facility.

U.S. patent application publication 2005/0015217 to Weidl et al. titled “Analyzing Events”, filed May 14, 2004, focuses on analyzing a facility after its completion. Weidl describes an analyzer arrangement that models operations of a paper processing plant to determine causes of possible issues by root cause analysis. Even though Weidl leverages modes, Weidl merely seeks to analyze a facility after it is operational after an owner operates the plant and fails to provide insight into readying the owner for the plant or readying the owner for other phases of a project.

Yet another example of using computers to model constructions includes U.S. patent application publication 2008/0249756 to Chaisuparasmikul titled “Method and System for Integrating Computer Aided Design and Energy Simulation”, filed Apr. 6, 2007. Chaisuparasmikul describes using an electronic construction plan to generate an energy efficiency analysis.

The above reference illustrate that computer modeling can be used for planning projects per se. However, these and other known references have failed to appreciate the aspect of the preparing or readying a new plant owner to begin operating their plant. What has yet to be appreciated is that readiness requirements can be leveraged from one project to the next and/or across different industries. For example, information regarding the readiness requirements can be compiled into a comprehensive “checklist” across many different projects. When building a new plant, a readiness analysis engine can be used in identifying relevant items from the checklist that pertain to readying an owner of the new plant. A Subject Matter Expert (SME) using the engine can then estimate costs to ready the owner by referencing one or more readiness models and incorporating the identified readiness items or their attributes into the readiness models. Generated readiness cost estimates would be more accurate by leveraging past experiences.

Thus, there is still a need for systems and methods of estimating operational readiness costs.

### SUMMARY OF THE INVENTION

The inventive subject matter provides apparatus, systems and methods in which a plant's operational readiness cost can be estimated. For example, a readiness analysis engine can be configured to analyze one or more readiness models incorporating plant attributes, possibly including building requirements, operation procedures development costs, maintenance equipment, or other attributes associated with a plant. The analysis engine can access a readiness checklist comprising readiness items (e.g., tasks, equipment, training, certifications, compliances, personnel hiring, etc.). Based on inputted plant attributes, an SME using the analysis engine can identify the relevant readiness items (e.g., equipment, activities, task, personnel, etc.) from the checklists, possibly a compressive readiness checklist and determine which items would be required to ready the owner. The items of the checklist can be linked based on predecessor-successor logic indicating which items are related to each other. The analysis engine can then apply a relevant readiness model to relevant checklist items to generate a readiness cost estimate. The cost estimate can be presented to a new plant owner by configuring an estimate interface to present a cost estimate report.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is an overview of a readiness estimation engine.

FIG. 2 represents an example readiness checklist database.

FIG. 3 represents an example readiness model database.

FIG. 4 is an example method for generating a readiness cost estimate.

### DETAILED DESCRIPTION

It should be noted that while the following description is drawn to a computer/server based readiness estimation engine, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing an infrastructure capable of guiding new plant owners through the process of readying a plant for operation.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Businesses that are in planning phases for preparing to design or to build a new plant are often required to complete thousands of tasks before starting up and operating their new facilities. New plant owners should include the costs of completing this work in their project budgets. The following disclosure discusses processes or knowledge-based models for estimating costs (e.g., labor, time, materials, money, equipment, tools, etc.) of completing operational readiness preparation activities for a new plant or production plant. One should note that an estimated “cost” could comprise various types of costs including a monetary cost, a time cost, an equipment costs, a human resource cost, tooling cost, application software program costs, or other types of resource expenditures.

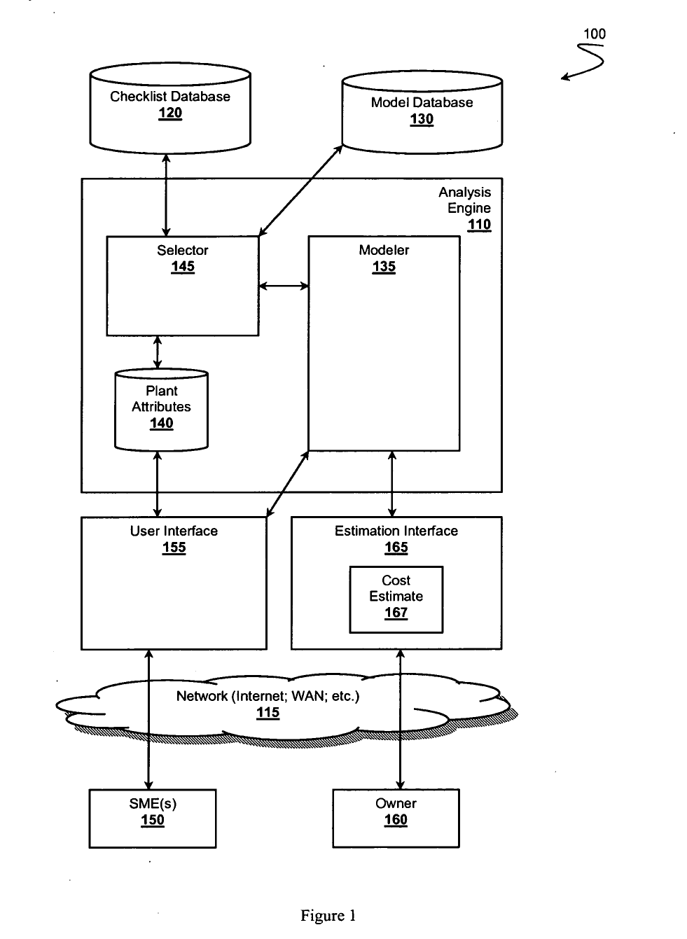

In FIG. 1, readiness estimation engine 100 can be utilized to generate readiness cost estimates or readiness plans for a new plant owner. Readiness estimation engine 100 can be considered a system of individual components communicatively coupled with each other over an internal network. In some embodiments, Readiness estimation engine 100 is provided as a service for the new plant owner by an EPMC firm engaged to complete construction of a plant.

Readiness estimation engine 100 can include readiness checklist database 120, readiness model database 130, analysis engine 110, user interface 155 and estimation interface 165. Local users (e.g., subject matter experts (SME) 150, remote users (e.g., owner 160) can access readiness estimation engine 100 over network 115 (e.g., WAN, LAN, the Internet, etc.) via user interface 155 or estimation interface 165. One or more SME 150, or other user, enters plant attributes 140 representing information relating to an actual plant construction. Analysis engine 110 can utilize plant attributes 140 to select one or more relevant readiness checklists stored in checklist database 120, or one or more relevant readiness models stored in model database 130. Once appropriate checklists or models are deemed relevant to the plant construction, analysis engine 110 can apply the selected relevant model(s) to relevant items within the selected checklist(s) to generate a readiness cost estimate.

Plant attributes 140 represent data reflecting aspects of an actual plant construction and can take on many different forms. Plant attributes 140 can be stored as various data objects including numbers, strings, data structures, or other types of data objects. Plant attributes 140 can also be single valued parameters or multi-valued parameters. Example multi-valued parameters including a (name, value) pair where the name represents a moniker by which the attribute can be referenced (e.g., “Temperature”, “Pressure”, etc.) and the value represents specific data for the attribute. In some embodiments, multi-valued attributes can include an N-tuple of information associated with a plant component or other asset.

Plant attributes 140 can carry information from all phases of a plant construction or from all scales associated with the plant construction. For example, plant attributes 140 can include data associated with stages of a plant life cycle from inception, design, engineering, construction, operation, management, commissioning, decommissioning, or even through to end-of-life. Furthermore, plant attributes 140 can include data from the component-level (e.g., bolts, valves, pumps, etc.) up through the project-level (e.g., site, owner, EPMC firm, etc.). Example scale levels can include asset level, component level, plant levels, site level (e.g., geography, location, etc.), jurisdiction level (e.g., city, state, province, country), or other levels.

Plant attributes 140 can be arranged in an organizational structure as desired. In more preferred embodiments, plant attributes 140 can be assigned names and values according a normalized, project-agnostic namespace. The namespace can be organized based on one or more desirable schemas. In some embodiments, the namespace can be organized hierarchically according to a generic plant construction project template. As plant attributes 140 are entered into the system, the template can be fleshed out for the specific plant construction.

Plant attributes 140 can be obtain automatically if desired. In some embodiments, analysis engine 110 can communicatively couple with one or more engineering modeling tools. For example, analysis engine 110 could be configured to obtain plant design attributes 140 from SmartPlant™, or other tools. Analysis engine 110 can convert the tool-specific representation of a modeled plant into the normalized namespace of the readiness estimation engine 100.

Checklist database 120 represents a database configured to store one or more readiness checklists associated with plant construction. Readiness checklists can come in many different types, possibly associated with different readiness scenarios at different phases of a construction project. For example checklists can be associated with design readiness, engineering readiness, construction readiness, operational readiness, or simply readiness for handing over to the new plant owner. One especially preferred checklist comprises a comprehensive checklist covering all phases of a construction project where the comprehensive checklist represent best practice activities or items that are considered useful to ready a plant owner to move through to a new phase of the plant construction, including taking ownership of the plant.

The checklists that are stored within checklist database 120 comprise readiness items that might or might not pertain to readying a plant owner on their specific plant construction. Readiness items can include equipment, tasks, personnel, events, or other types of items that would be considered necessary to complete owner readiness. Each item can also comprise attributes describing how the item relates to a plant construction's readiness. The item attributes can also be stored as project-agnostic data, possibly according to the same namespace used for plant attributes 140.

In a similar fashion, model database 130 represents a database storing one or more readiness models. A readiness model can include one or more modules configured to convert known checklist items and plant attributes 140 into a cost estimate. Example readiness models can include spreadsheets, software simulations, Monte Carlo applications, or other types of digital models. The readiness models stored in model database 130 can also configured to address different types of readiness at all phases of a plant construction as discussed above with respect to checklist database 120. In addition, readiness models are considered construction project agnostic and can be applied to one or more different construction projects. Models, as with other data objects in the system can include one or more assigned model attributes that fall within the same namespace as plant attributes 140, checklist attributes, item attributes, or other object attributes.

As SME 150, or other authorized user, enters plant attributes 140, analysis engine 110 can use selector 145 to determine which checklists from checklist database 120 would be considered relevant to the plant construction currently under consideration. The relevant checklists can be identified via selector 145 by comparing plant attributes 140 with the attributes associated with the checklists. If the comparison satisfies selection rules, then a checklist is deemed to be relevant. For example, selector 145 might identify that a comprehensive readiness checklist is relevant because plant attributes 140 indicate that the plant construction is nearly complete and a final set of readiness activities or items are considered warranted.

Still, one should note that relevant checklists might have readiness items that are irrelevant to a plant construction. Selector 145 can construct a project specific checklist by filtering out irrelevant checklist items; leaving behind readiness items identified as being relevant to the plant construction under consideration.

Just as selector 145 identifies which checklist items are relevant to a plant construction; selector 145 can also determine which models stored in model database 130 are considered relevant readiness models for the plant construction under consideration. Selector 145, again, can compare plant attributes 140 against attributes assigned to the models. If the comparison satisfies the model selection rules, the model is considered relevant.

Upon identification or selection of relevant readiness items and relevant models, modeler 135 can apply the relevant models to the readiness items to generate a readiness cost estimate. For example, the relevant items can be part a project specific checklist having data fields populated with actual values obtained from plant attributes 140. The relevant items can be inserted, or otherwise inputted, into the relevant model, which can then be run by modeler 135 to generate a result. The relevant model can be as simple as spreadsheet or as complex as a series of one or more Monte Carlo applications.

Regardless of the complexity of the model, the modeler 135 can generate one or more of readiness cost estimate 167, which can be presented to owner 160 via estimation interface 165. Readiness cost estimate 167 can comprise one or more cost estimates as selected or desired users of analysis engine 110 (e.g., owner 160, SME 150, etc.). Example readiness cost estimates include different types of costs: monetary cost, amount of time, pieces of equipment, number of personnel, amounts of materials, or other quantities.

Estimation interface 165 can be configured to present readiness cost estimate 167 according to different schemes as desired. In some embodiments, estimation interface 165 can operate as a web server capable of rendering a web page local to owner 160 and presenting readiness cost estimate 167 as a web page, possibly a spreadsheet or other type of report. Estimation interface 165 could also operate as an application interface through which owner 160 can interact with an interactive readiness cost estimate 167. For example, estimation interface 165 can present user controls to adjust the operation of modeler 135 where owner 160 could adjust parameters of a readiness simulation or Monte Carol application to determine how readiness cost estimate 167 changes as parameters of the model changes.

As a more complete example, consider a scenario where owner 160 is in the early process of developing a plant design. Owner 160 could adjust plant attributes 140 related to the design in order to gain an understanding of their readiness for beginning construction. Owner 160 could change a jurisdiction plant attribute 140 to see if readiness cost estimate 167 would change based on moving the plant design to a new jurisdiction.

One should appreciate that analysis engine 110 can be utilized by multiple users for multiple, distinct projects at the same time. For example, a first instance of plant attributes 140 can be associated with a first specific plant construction project, while a second, distinct instant of plant attributes 140 can be associated with a completely different second plant construction project. In fact, each plant construction object could have different owners 160. To support multiple different projects, checklist database 120 and model database 130 can be configured to store their respective data objects in a project agnostic format.

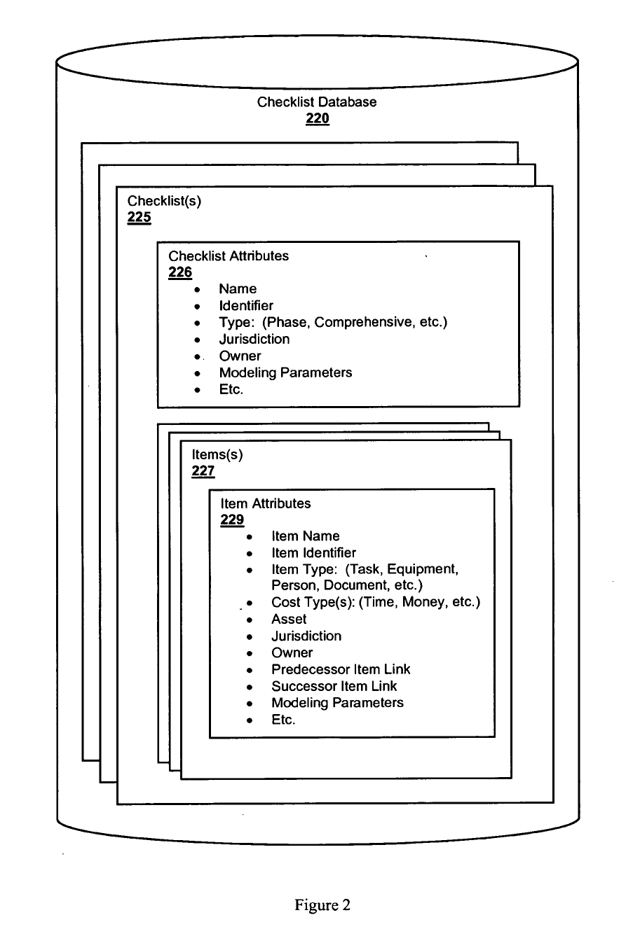

In FIG. 2 checklist database 220 stores one or more checklists 225, each having one or more readiness checklist items 227. Checklists 225 represents a compilation of checklist items 227 that are considered useful when determining owner readiness with respect to phase deliverable; readiness the new plant owner to take ownership for example. The compilation also represents lessons learned across multiple past projects and can be considered to cover various known best practices.

In more preferred embodiments, checklists 225 are considered distinct manageable objects. Each checklist 225 can include one or more checklist attributes 226 describing the nature of their corresponding checklist 225. Checklists attributes 226 can cover a wide variety of information including name, identifier, type of checklist, relevant jurisdictions, relevant owners, checklist-level modeling parameters, or other types of attributes assigned to the checklist 225. Checklists 225 can be accessed, searched, or updated as required possibly through submitting one or more queries constructed to operate on checklists 225 via its checklist attributes 226. For example, one could search for all readiness checklists 225 having a “China” jurisdiction checklist attribute 226. Furthermore, as mentioned previously, checklists attributes 226 can adhere to a standardized or normalized namespace so that they can be easily compared to other objects in the system.

Each of readiness checklists 225 can include one or more readiness checklist items 227, which corresponds to an items that should be considered in a satisfactory state before readiness can be considered complete. For example, a readiness item 227 might include a piece of equipment. When the specific piece of equipment is ready (e.g., at a proper location, having proper personnel assigned or trained, etc.), then it would be considered in a satisfactory state. One should keep in mind readiness items 227 do not necessarily have to be in a satisfactory state at the time the checklist 225 is consulted because the construction project is still underway.

The readiness items 227 in a checklist 225 might be over inclusive relative to a specific plant construction project where one or more readiness items 227 are considered relevant to the project while others are not relevant to the project. Relevant readiness items 227 can be identified as being relevant to a project by comparing the plant attributes of the project with checklist attributes 226 or with item attributes 229.

Readiness items 227 can include many different types of items. Example items can include equipment, personnel, documentation, tasks, or other types of requirements to ensure proper owner readiness for a project phase. Each of item attributes 229 provides a quantum of information describing its corresponding item 227. Examples item attributes 229 include names, identifiers (e.g., UUID, GUIDs, etc.), type, associated costs for the item, asset-level information, relevant jurisdictions, owners, modeling parameters or other types of attributes. Again, as with other objects in the system, item attributes 229 can conform to a common namespace.

Two especially preferred item attributes 229 comprise predecessor item and successor item links. These links indicate relationships with other items 227, possibly within other checklists 225. The predecessor item link indicates a readiness item 227 that should be in a satisfactory state before the current item can be considered in a satisfactory state. As an example, a readiness item 227 might correspond to having a piece of equipment on a construction site. The predecessor item might include a task of purchasing the piece of equipment. Similarly, successor item link indicates a readiness item 227 that could be considered a necessary item in chain of items to establish readiness. To continue the previous example, a successor item to the equipment might include tasks for assigning a person to the equipment or training the person on the equipment's use. Additional relevant readiness items 227 can be identified via predecessor-successor logic even when the predecessor items or successor items lack readiness item attributes 229 that satisfy item selection rules with respect to the plant attributes. Such items might otherwise appear unrelated to a plant, but still would be considered relevant based on the predecessor-successor logic analysis.

Of particular note, readiness item attributes 229 can include information related to modeling item 227 within a readiness model to determine a readiness cost estimate. Naturally, the modeling parameters could take on many different forms depending on the nature of item 227 and its associated costs. The modeling parameters might include one or more algorithms or formulas that can be used to represent a cost metric associated with item 227. In the equipment example above, modeling parameters relevant to establishing a cost could include lead times of acquiring the equipment, sources for purchasing prices, risk or safety metrics per unit time of use, or other types of information that can be used to determine a cost estimate. To extend the example further, the equipment type can be identified as being unique or duplicate. Unique equipment might incur higher readiness cost while a duplicate equipment might a lower readiness cost.

A comprehensive readiness checklist 225 can be provided that includes a list of items or activities that might be required to ready a plant owner. For example, the readiness checklist could include items relating to maintenance readiness, operations readiness, systems readiness, organizational readiness, support readiness, supply chain readiness, risk and owner readiness reviews, or other types of readiness. One known system that could be adapted to operate according to the disclosed techniques includes the FLUOR® UpFRONT^{SM} Operational Readiness and Start-Up Support service.

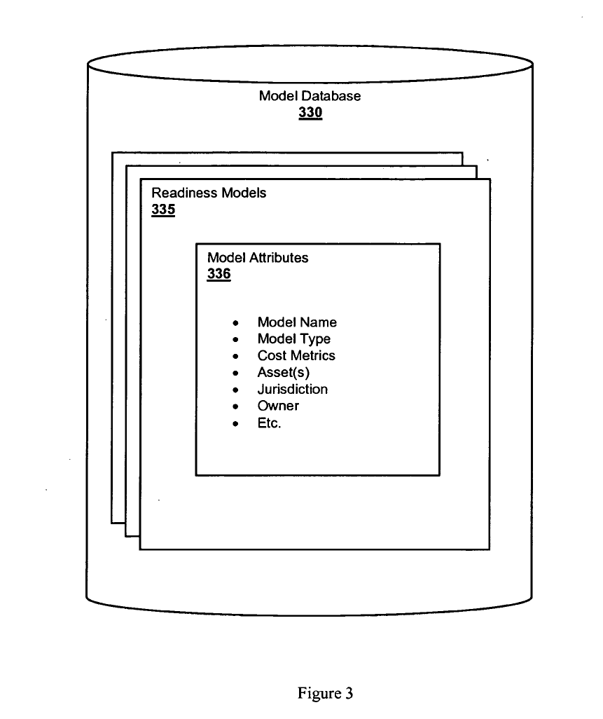

In FIG. 3, model database 330 is configured to store one or more readiness models 335, preferably in a project agnostic manner. As with other objects in the system readiness models 335 can also comprise attributes as indicated by model attributes 336. Models 335 can include various types of applications configured to generate one or more readiness cost estimates. Example models include spreadsheets, modeling programs, simulations, or even Monte Carlo applications.

Readiness models 335 comprise one or more model attributes 336 that provide information regarding under which circumstances the model are considered relevant. Again, readiness models 335 can be identified as being relevant to a project based on comparing plant attributes with readiness model attributes 336. Typically, model attributes 336 have a higher level or more global perspective than that of checklist attributes, readiness item attributes, or other more detailed level attributes. For example, model attributes 336 can include over all cost metrics for a readiness scenario or a jurisdiction to which the model is considered relevant. Still, it is contemplated that model attributes 336 can include finer levels of detail as well, even down to an asset level. In some embodiments, model attributes 336 could indicate that model 335 is only relevant for a specific owner or other specific aspect of a project rather than being relevant to many distinct projects.

Models 335 are used to fold together various information from other components of the system to derive a readiness cost estimate. Relevant readiness models 335 can be combined with relevant checklist items, readiness item attributes, or plant attributes to develop a readiness model for the plant. In embodiments where model 335 comprises a spreadsheet, the information obtained from the readiness items attributes and plant attributes can be inputted into the spreadsheet to generate one or more relevant cost metrics. In embodiments where model 335 comprises a simulation, the simulation can be configured according to the various attributes. The simulation can then be run to determine the cost metrics. Cost metrics can be based on time, equipment, amount of material, quality, risk, safety, personnel, or other quantifiable factor.

Readiness models 335 can be built based on past experiences. For example, readiness model 335 can comprise an a priori model established before the construction of the plant that is currently being considered. The a priori model embodies the lessons learned about readying a plant owner based on previous construction projects. When the analysis engine seeks to select one or more readiness models 335, the selected model can be one of the a priori models, newly created models, or other model 335 in model database 330.

Readiness models 335 are configured to generate one or more readiness cost estimate comprising at least one derived cost metric. One should keep in mind that many of the relevant checklist items considered to pertain to a project might not be in a satisfactory state with respect to readiness. Therefore, the readiness cost estimate or cost metrics might not have a deterministic value.

The number of unique vs. duplicate quantities can also be determined, and loaded into the models. Generally unique items would require additional time to design (e.g., a high readiness cost) where duplicate items would have less time to design (e.g., a low readiness cost) associated with them, which could affect an estimated readiness cost.

Readiness models 335 can also be executed as a simulation multiple times as in a Monte Carlo environment to determine a spread on cost metrics. Running a simulation multiple times having different input parameters can provide confidence in a readiness cost estimate and in its cost metrics. Consider an example where a person is assigned a task (i.e., relevant readiness item). A first person assigned the task might increase a cost metric; however, when a second, different person is assigned the task the cost metric might decrease. Readiness models 335 can be leveraged to determine a spread in a readiness cost estimate.

One should appreciate that running a simulation multiple times allows for building statistics regarding achieving proper readiness. The inventive subject matter is considered to include using the statistics to generate a likelihood of achieving the desired readiness. In addition, varying input attributes (e.g., personnel assign to a task, available equipment, etc.) into relevant readiness models 335 also provides for optimizing one or more cost metrics associated with the readiness cost estimate. As input attributes are varied the owner can determine how best to save time, money, effort, equipment, or even reduce risk. For example, model 335 could be adjusted to accommodate equipment type (e.g., unique, duplicate, etc.)

One method of varying personnel attributes can include using a responsibility matrix having known personnel with identified skill metrics or capabilities. The analysis engine can change resource assignments by consulting the matrix to determine if other individuals could be assigned to tasks, equipment, or other checklist items. If an individual has an appropriate set of skills or capabilities (i.e., attributes), then the individual might be a suitable replacement for a less efficient individual.

In view readiness models 335 can be leveraged as a simulation to achieve readiness; one should appreciate that a readiness model 335 can also be leveraged to generate a readiness plan. When a desirable readiness cost estimate has been completed, possibly including cost metric optimization, readiness model 335 can be used to output a recommended readiness plan having checklist items, assigned resources, linked items (e.g., link checklist task, predecessors, successors, etc.), or other information outlining how to achieve proper readiness. Furthermore, the recommended readiness plan can also include a likelihood of success, itemized cost metrics, itemized risk factors, or other information useful to a plant owner.

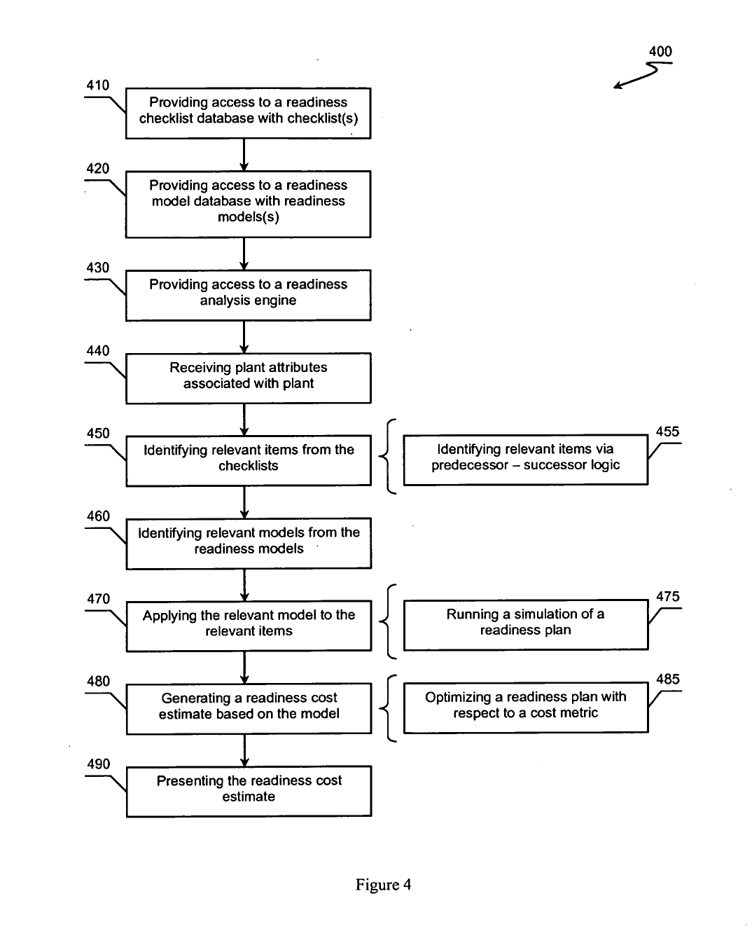

In FIG. 4, method 400 represents a possible method for generating a readiness cost estimate. Method 400 outlines how the various elements described above interact to yield one or more readiness cost estimates.

Step 410 includes providing access to a readiness checklist database storing one or more readiness checklists. The checklists are considered living documents that can be added, removed, updated, or otherwise modified as time passes or as lessons are learned through readying owners from previous construction projects. In more preferred embodiments, checklists are stored in a project agnostic manner. For example, checklists could be stored as XML data structures. Each of the checklists can include checklist attributes and can include one or more readiness checklist items also having readiness item attributes. As discussed above, the various data objects in the system can have attributes adhering to a common namespace so the objects can be readily compared with each other according to one or more selection rules (e.g., Boolean logic, programmatic instructions, correlations, etc.).

Step 410 includes providing access to a readiness model database storing one or more readiness models. The readiness models can also be identified by attributes as with other objects in the system. Readiness models can range from simple spreadsheets through complex instructions sets representing simulations of a readiness scenario or even Monte Carlo applications.

Step 430 includes providing access to a readiness analysis engine that can communicatively couple with the checklist database and model database. Users can access the readiness analysis engine via one or more user interfaces possibly presented over a network (e.g., the Internet). In some embodiments, users can gain access to the readiness analysis engine via web pages served by an HTTP server within the analysis engine. While in other embodiments, access can be gained through one or more software applications running local to the users.

Step 440 includes receiving plant attributes associated with a plant. For example, a user, possibly a subject matter expert, can enter project specific information into the analysis engine where the project specific information is presented in the form of the plant attributes. As mentioned previously the plant attributes can be normalized to a common namespace so that one set of attributes can be easily compared with another set of attributes, possibly on a different object. Plant attributes can also be obtained automatically from one or more design tools. For example, the analysis engine can couple with a 3D modeling tool to obtain geometric attributes, part lists, equipment descriptions (e.g., unique, duplicate, off-the-shelf, etc.), or other attributes.

At step 450 the analysis engine can use the plant attributes to identify relevant readiness items from checklists stored in the checklist database. Identifying the relevant items can include comparing the plant attributes with checklist attributes or checklist item attributes. If the analysis engine finds that checklist items satisfy comparison selection criteria relative to the plant attributes, the checklist items are deemed to be relevant checklist items to be used for estimating readiness cost estimate. In addition, at step 455, the analysis engine can walk predecessor or successor links following predecessor-successor logic in relevant checklist items to identify additional relevant checklist items.

Step 460, in similar fashion as step 450, can include identifying relevant readiness models from the readiness model database. The analysis engine can compare the plant attributes to the attributes associated with various readiness models. If the comparison yields a satisfactory result, the readiness model is deemed relevant to the current plant construction project.

Step 470 includes applying the relevant readiness model to the relevant readiness items. The analysis engine obtains information from the relevant readiness items, including their attribute information, and inputs the information into the relevant readiness model. For example, a model might require an estimated time frame to complete a task which can be obtained from the item task's attributes. The estimated time frame can be inputted into the model as a parameter of the model. The model could then adjust the estimated time frame as necessary by one or more scaling factors associated with personnel assigned to the task. The model can combine many time frames to generate a final estimated time frame (i.e., an estimated cost metric) to achieve readiness. Such an approach can be achieved through the use of a spreadsheet application.

In some embodiments, step 475 can include running one or more simulations of readiness plan. The readiness plan can be generated from the model by itemizing the relevant checklist items that should be in a satisfactory state to achieve readiness. Furthermore, the analysis engine can assign personnel, equipment, or other resources to each of the items so that the plan is fleshed out sufficiently for the simulation. The simulation can be run multiple times to derive statistics associated with achieving readiness.

A readiness plan can include one or more readiness requirements. Example readiness requirements can include risk management, training, operation procedures, human resource planning, employee training, maintenance procedures, spare parts planning, supply chain activities, enterprise I/T systems, regulatory compliance, commissioning, readiness reviews, process certifications, etc.

Step 480 can include generating a readiness cost estimated based on the model. As discussed above, the readiness cost estimated can be generated from the model through various methods. In some embodiments, the model generates the readiness cost estimated based on one or more cost metrics calculated from applying formulas or algorithms to plant attributes or relevant checklist attributes. In more complex embodiments, the model represents a simulation that yields the cost metrics. For example, the analysis engine can allow values of attributes to vary, assuming the attributes do not have fixed values, and run the model simulation multiple times, possibly within a Monte Carlo application. By varying input parameters to the relevant model, the analysis engine can determine if a cost estimate or its cost metric have significant variance.

In fact, step 485 can include optimizing a readiness plan with respect to a cost metric. As the analysis engine varies the model's input parameters, the resulting readiness cost estimate likely changes as well. Thus, one can use the analysis engine to optimize the readiness plan by seeking variable attribute values that yield an optimized cost metric. Optimizing cost metrics could increase/decreasing cost metric values: money, time, effort, risk, safety, equipment, materials, or other types metrics.

Step 490 includes presenting the readiness cost estimate. Presenting the cost estimate can include configuring a remote computer to render a report comprising itemized listing of various relevant checklist items, cost metric, recommended readiness plans, or other information. In some embodiments, the readiness cost estimate can be constructed as an interactive application that a user can control or interact with to determine the scope of the cost estimate. Preferably a plant owner can utilize the presented cost estimate to determine how be to achieve readiness one or more construction phases or taking over of their plant.

There are numerous advantages for the disclosed techniques. The disclosed process is flexible and modular. Through leveraging past experiences, a tailored readiness plan can be quickly established to create a client's fit-for-purpose cost estimates.

Cost estimates can be organized by major activity for review or budgeting purposes by the new plant owner. For example cost estimates can be itemized by activities, equipment, human resources, time, or other types of costs. The estimates can also be itemized by types of readiness: maintenance, supply chain, support, systems, or other types of readiness.

It is also contemplated that the disclosed system could be used for a broad range of industries and different types of new production facilities. For example, the disclosed analysis engines and techniques would be useful as artificial intelligence engineering design application to aid designers to evaluate the cost of design alternatives. It can be used by companies to select a design configuration which reduces the operational readiness preparation costs, and optimizes the life cycle cost of the new plant.

One should also appreciate that the readiness cost estimates or readiness plans can be generated before or during construction of a plant. Such an approach ensures a plant owner has accurate information in a timely fashion to make solid decisions regarding the plant's development.

Various industries could leverage such techniques as a decision support system where individuals can evaluate alternative designs or can gain an understanding of differential costs among decisions.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A readiness estimation engine, the engine comprising:
a plant readiness model database configured to store one or more readiness models, the models having model attributes;
a readiness checklist database configured to store one or more readiness checklists, the checklists comprising readiness items having item attributes;
a readiness analysis engine communicatively coupled with the model database and checklist database and configured to:
receive plant attributes associated with a plant;
identify relevant readiness items from checklists in the checklist database by comparing the plant attributes with the item attributes;
identify at least one relevant readiness model in the model database based on the plant attributes; and
generate a readiness cost estimate by applying the at least one relevant readiness model to the relevant readiness items; and
an estimation interface coupled with the analysis engine and configured to present the readiness cost estimate.

2. The engine of claim 1, wherein the readiness analysis engine is further configured to identify relevant readiness items via predecessor-successor logic applied to checklist items.

3. The engine of claim 1, wherein the readiness analysis engine is further configured to generate a readiness plan based on the identified readiness items.

4. The engine of claim 3, wherein the readiness analysis engine is further configured to optimize the readiness plan with respect to a cost metric.

5. The engine of claim 3, wherein the at least one readiness model comprising a simulation of a readiness plan.

6. The engine of claim 1, wherein at least one relevant readiness model comprises an a priori model established before construction of the plant.

7. The engine of claim 6, wherein the readiness analysis engine is further configured to select the at least one plant readiness model from among a plurality of established readiness models.

8. The engine of claim 1, wherein the readiness analysis engine is further configured to identify relevant readiness items according to equipment type including at least one of the following types: a unique equipment, and a duplicate equipment.

9. The engine of claim 8, wherein the plant readiness model is adjusted to accommodate the equipment type.

10. The engine of claim 1, wherein the readiness cost estimate comprises an itemization of cost according to the relevant checklist items.

11. The engine of claim 1, wherein the readiness cost estimate comprises an itemization of cost according to cost type.

12. The engine of claim 1, wherein the readiness cost estimate comprises different cost types including at least two of the following cost types: a monetary cost, a time costs, a labor cost, and a quantity of equipment.
